(19) United States
(12) Patent Application Publication
(10) Pub. No.: US 2008/0087590 A1
(43) Pub. Date: Apr. 17, 2008

(54) Integrated fluid valve assembly

(75) Inventor: James Jergens, Troy, OH (US)

Correspondence Address: ICE MILLER LLP, ONE AMERICAN SQUARE, SUITE 3100, INDIANAPOLIS, IN, 46282-0200, US

(73) Assignee: West Troy Tool & Machine, Inc., Troy, OH (US)

(21) Appl. No.: 11/546,761

(22) Filed: Oct. 12, 2006

(51) Int. Cl. B01D 27/10

(52) U.S. Cl. 210/130; 210/136; 210/420; 210/433.1; 210/450

(57) ABSTRACT

An integrated fluid valve assembly comprising a valve having a flexible head, a stem, and at least one leg. In at least one embodiment of the present invention, a fluid valve assembly comprises a retainer and a valve. The valve may be made of a single integrated part that interacts with the retainer to control fluid flow through a fluid system, such as to maintain fluid flow through an automotive oil filter when the filter itself becomes clogged. The valve automatically permits fluid flow through an aperture when the fluid pressure rises to a predetermined set point. In another embodiment of the present invention, a cartridge fluid filter comprises a center tube, a filter media, and a valve that reversibly closes a bypass aperture. In another embodiment of the present invention, a fluid filter includes a center tube, a filter media, a valve that reversibly closes a bypass aperture, and a canister enclosing the center tube, filter media, and valve.

### BACKGROUND OF THE INVENTION

There is known a wide variety of valves used to control fluid flow. Such valves may have a number of uses, including to provide a pressure relief when fluid pressure increases above a certain point or to prevent fluid backflow. Although such valves can be used in various applications, they are commonly used in, for example, oil filters for automobile engines or other internal combustion engines. Many fluid filters include some type of relief valve to help regulate fluid pressure. A relief valve, which can also be known as a bypass valve, allows fluid to flow through the filter assembly to its destination despite a blockage in the filter itself. For example, many automotive oil filters include relief valves that permit oil flow to the engine even when the oil filter media becomes clogged with particulate impurities. Such relief valves protect the engine from damage due to inadequate lubrication by enabling the oil to bypass the clogged filter media and reach the engine, albeit in an unfiltered state. Similarly, an anti-backflow valve, or anti-siphon valve, in an automotive oil filter protects the engine from inadequate lubrication by preventing oil in the engine from flowing backwards out of the engine into the filter.

Many types of fluid valves, including fluid filter relief valves, are often made from several components, which must be carefully formed and assembled during production. Valves made from fewer components are easier and less expensive to make than those made from a greater number of components. For example, many current filter assemblies use a relief valve made from at least three separate parts, including a steel retainer, a plastic valve, and a steel spring. In most of these assemblies, the plastic valve and steel spring must be made so that they connect during production. Such a connection not only increases the complexity and cost of making one or both of the parts, but it also increases the complexity and cost of assembling the filter.

It is therefore desired to provide an integrated fluid valve assembly that uses fewer parts, is easier to make, and costs less, but that nevertheless provides proper fluid control based on fluid pressure.

### SUMMARY

Certain embodiments of the present invention comprise fluid valve assemblies. Other embodiments of the present invention comprise fluid filters containing valve assemblies. Filters and valves made in accordance with various aspects of the present invention have fewer parts, are easier to manufacture, and are less expensive to produce than many other filters and valves, particularly those traditional filters and valves having a steel retainer, plastic valve, and steel spring. In addition, the parts used to make various filters and valves of the present invention are less costly to handle and store, reducing inventory-related costs.

In at least one embodiment of the present invention, a fluid valve assembly comprises a retainer and a valve. The retainer may be of a substantially planar or substantially conical shape, with a first surface and an opposing second surface, and includes an outside edge framing its circumference and an inside annular edge framing an aperture in the retainer. Disposed circumferentially adjacent to the inside annular edge on the first surface of the retainer is an annular ledge.

The valve fits within the aperture of the retainer and comprises a flexible valve head, a valve stem, and at least one leg. One end of the valve stem is axially connected to the valve head, while the other end is connected to the at least one leg. The valve may be made of a single integrated part.

The valve head is generally shaped like a disc and is configured so that it can contact the annular ledge of the retainer, covering the entirety of the aperture. When the valve head and the annular ledge are engaged, such as, for example, during the normal operation of a fluid filter, the valve head engages the annular ledge of the retainer to form a seal so that a substantial amount of fluid cannot leak through the aperture in the retainer. However, when the valve head and the annular ledge are not engaged, fluid can flow through the aperture in the retainer.

The valve disengages from the retainer, thereby opening the retainer aperture, when the fluid pressure rises to a predetermined set point, causing the valve head to raise and forcing the leg or legs to flex outwardly, thereby causing the valve head to disengage from the annular ledge. Once the seal between the valve head and the annular ledge is broken, fluid begins to flow through the aperture. For example, when the valve assembly is installed in a fluid filter as a relief valve, the aperture provides a route for fluid to bypass the filter media in the fluid filter and flow out of the fluid filter.

In another embodiment of the present invention, a cartridge fluid filter is capable of insertion into a receptacle for fluid filtration. One embodiment of a cartridge fluid filter of the present invention comprises a top end cap, a filter media, a bottom end cap, a center tube, a retainer, and a relief valve. The center tube is hollow and may contain multiple holes through which fluid can flow. Formed around the outside of the center tube is the filter media. The top end cap is attached to one end of the filter media, while the bottom end cap is attached to the other end of the filter media. The relief valve comprises a flexible valve head, a stem, and at least one leg. The valve is configured to regulate fluid flow into or out of the center tube by opening and closing a bypass aperture formed in the retainer.

In another embodiment of the present invention, a fluid filter comprises a center tube, a filter media, and a relief valve assembly enclosed in a canister. The filter media surrounds the center tube, and the relief valve reversibly closes a bypass aperture to regulate fluid flow through the fluid filter. Between the filter media and the canister is an outer circumferential space that serves as a fluid passageway for delivering fluid to or from the filter media. In a bypass situation, the relief valve opens, permitting fluid to flow through the bypass aperture, bypass the filter media, and flow out of the canister to its destination. The fluid filter thereby delivers substantially uninterrupted fluid flow even when the filter media becomes clogged. In some embodiments of the fluid filter of the present invention, the fluid filter further comprises a second valve assembly that acts as an anti-siphon valve.

### BRIEF DESCRIPTION OF THE DRAWINGS

FIG. 1 shows a perspective view of an embodiment of a valve assembly according to the present invention, wherein the valve is in the closed position;

FIG. 2 shows a top perspective view of an embodiment of a retainer according to the present invention;

FIG. 3 shows a bottom perspective view of the retainer of FIG. 2;

FIG. 4 shows a side view of an embodiment of a valve according to the present invention;

FIG. 5 shows a bottom perspective view of the valve of FIG. 4;

FIG. 6 shows a sectional view of an embodiment of a valve assembly according to the present invention, wherein the valve is in the closed position;

FIG. 7 shows a sectional view of the valve assembly of FIG. 6, wherein the valve is in an open position;

FIG. 8 shows a sectional view of an embodiment of a valve assembly according to the present invention, wherein the valve is in the closed position;

FIG. 9 shows a sectional view of an embodiment of a fluid filter according to the present invention;

FIG. 10 shows a sectional view of an embodiment of a cartridge fluid filter according to the present invention; and

FIG. 11 shows a sectional view of another embodiment of a cartridge fluid filter according to the present invention.

### DETAILED DESCRIPTION

It will be appreciated by those of skill in the art that the following detailed description of the preferred embodiments is exemplary in nature and is not intended to limit the scope of the appended claims.

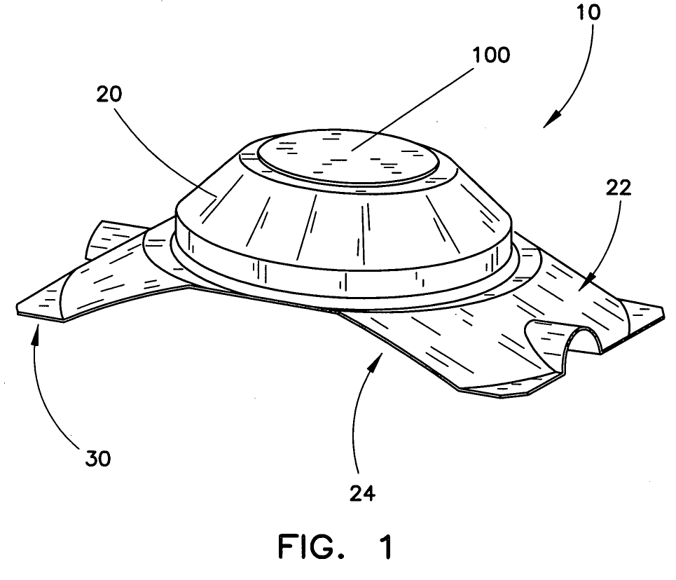

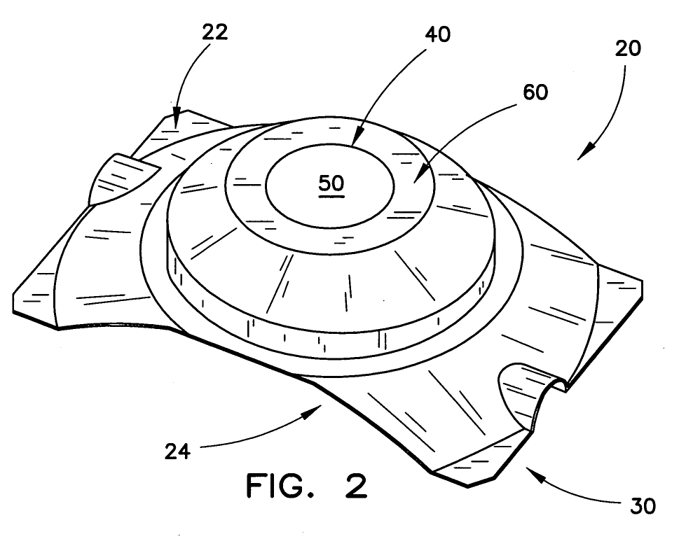

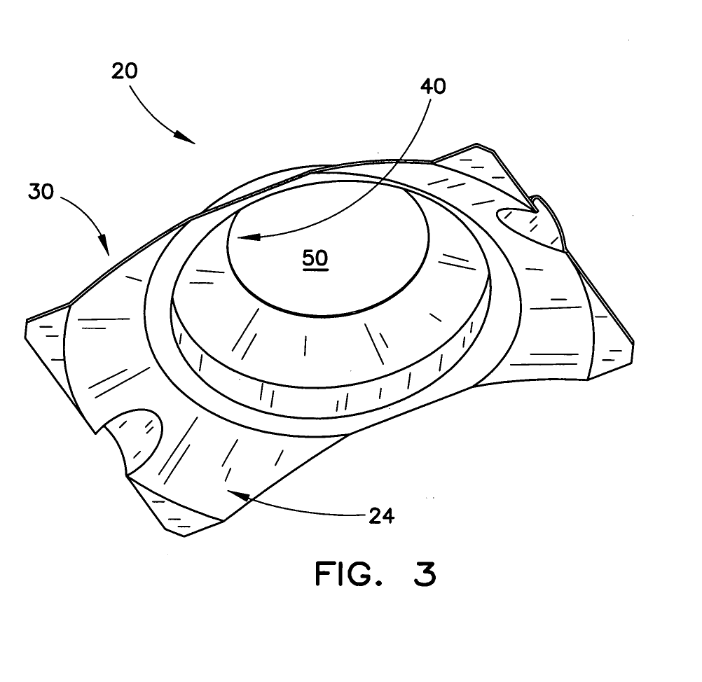

Referring now to FIG. 1, there is shown one embodiment of a fluid valve assembly of the present invention. In this embodiment, valve assembly 10 comprises retainer 20 and valve 100. Retainer 20 may be substantially planar or substantially conical. The embodiment of retainer 20 shown in FIGS. 2 and 3 is substantially conical, such that first surface 22 of retainer 20 is substantially convex and second surface 24 of retainer 20 is substantially concave. Retainer 20 may be made of any suitable material with sufficient strength, such as steel or plastic.

As shown in FIGS. 2 and 3, retainer 20 includes outside circumferential edge 30 and inside annular edge 40. Outside circumferential edge 30 is substantially rectangular, as shown in FIGS. 1-3, but may instead be of any shape, such as substantially circular, depending on the specific application in which the valve assembly is to be used.

Inside annular edge 40 defines aperture 50, as shown in FIG. 2. Inside annular edge 40 may be of any configuration such that aperture 50 is of any shape, but a substantially circular shape is preferred for many applications. Annular ledge 60 is that portion of first surface 22 of retainer 20 that circumferentially surrounds inside annular edge 40. In the embodiment shown in FIG. 2, annular ledge 60 is a flat, horizontal portion of first surface 22. However, annular ledge 60 may be of any size and shape, and may be configured on either first surface 22 or second surface 24 of retainer 20, so long as annular ledge 60 is capable of engagement with valve 100 to form a seal through which a substantial amount of fluid cannot pass.

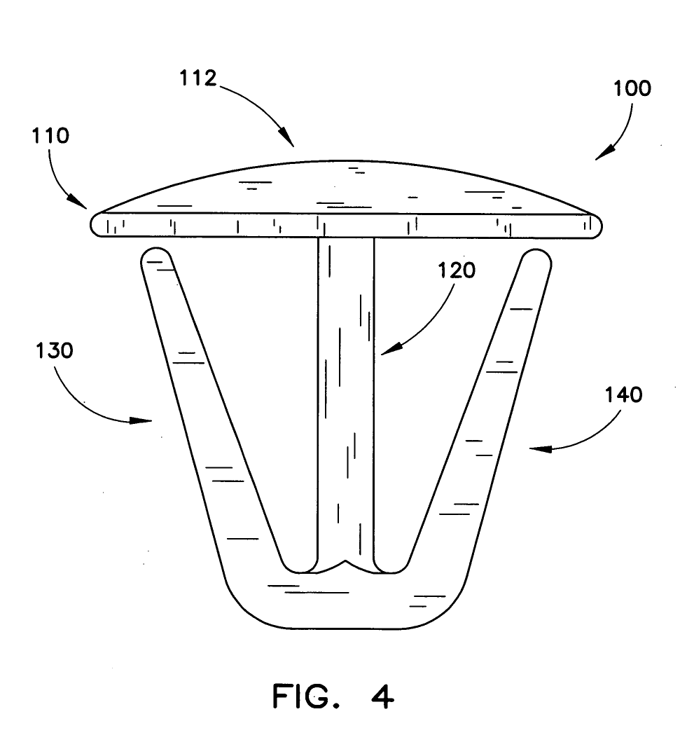

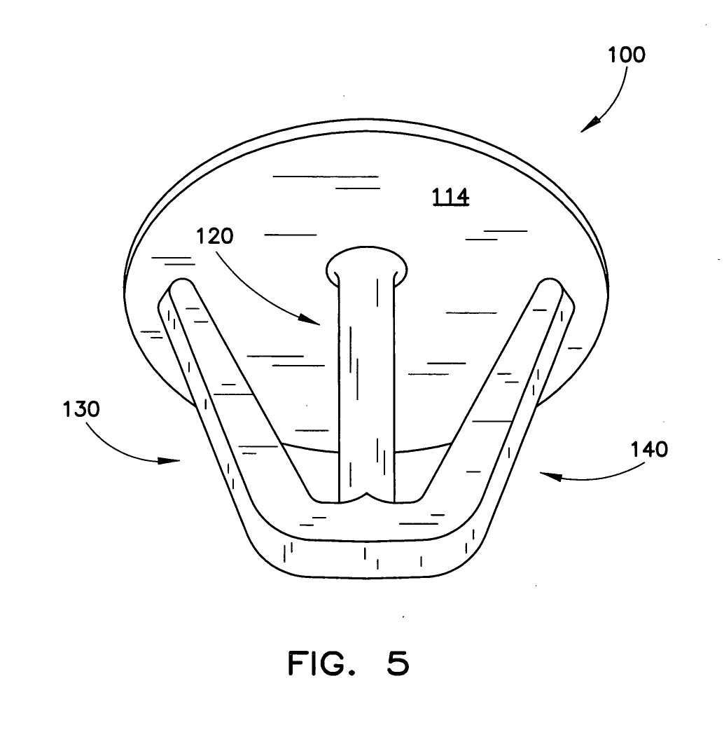

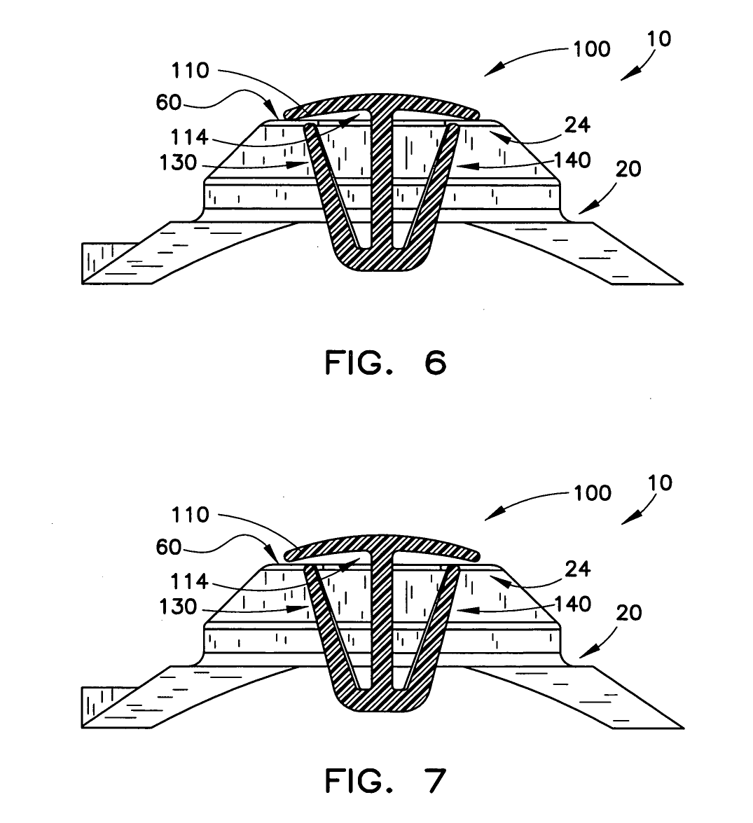

Referring now to FIGS. 4 and 5, valve 100 fits within aperture 50 and consists of flexible valve head 110, valve stem 120, and legs 130, 140. Flexible valve head 110 has first surface 112, which is generally convex-shaped, and second surface 114, which is generally concave-shaped. Flexible valve head 110 is formed in the same general circumferential shape as aperture 50, so that flexible valve head 110 can cover aperture 50, as shown in FIGS. 1 and 6, when retainer 20 and valve 100 are fully engaged. Further, flexible valve head 110 is shaped such that second surface 114 of flexible valve head 110 can engage annular ledge 60 to seal aperture 50 so that only minimal fluid can flow through aperture 50. While it is preferable for most applications that flexible valve head 10 completely cover aperture 50 so that no fluid can flow through aperture 50 when retainer 20 and valve 100 are fully engaged, embodiments of the present invention also include valve assemblies that do not completely block fluid flow through aperture 50. Flexible valve head 110 is made from a relatively flexible material, which may include plastic, rubber, flexible metal, carbon fiber, silicon, or any other flexible material having sufficient stiffness to maintain suitable engagement between retainer 20 and valve 100.

Referring again to FIGS. 4 and 5, one end of valve stem 120 is attached to second surface 114 of flexible valve head 110. Valve stem 120 is preferably attached near the center of second surface 114, as shown, but may be attached anywhere on second surface 114 so long as the positioning of valve stem 120 does not obstruct engagement of second surface 114 with annular ledge 60 to form a seal. Similarly, valve stem 120 is shown extending axially from flexible valve head 110, but valve stem 120 may extend from flexible valve head 110 at almost any angle, so long as the positioning of valve stem 120 does not obstruct engagement of second surface 114 with annular ledge 60 to form a seal. Although one valve stem is preferred, multiple valve stems may be used.

Attached to the opposite end of valve stem 120 are legs 130, 140. Although two legs is preferred, as shown in FIGS. 4 and 5, a valve may have only one leg or more than two legs. Legs 130, 140 are preferably made from the same material as valve stem 120 and flexible valve head 110, but may be made of a different material, so long as legs 130, 140 are capable of sufficient flexion. As shown in FIG. 6, each of legs 130, 140 should be of sufficient length to contact second surface 24 of retainer 20 when flexible valve head 110 and annular ledge 60 are fully engaged to form a seal. Legs 130, 140 should be made so that they flex outwardly from valve stem 120 when the fluid pressure against second surface 114 of flexible valve head 110 raises to a predetermined set point.

During production of valve assembly 10, flexible valve head 110 is compressed at first surface 112 while inserted into aperture 50 of retainer 20. When flexible valve head 110 is compressed, legs 130, 140 are drawn toward valve stem 120. When flexible valve head 110 is released, legs 130, 140 move away from valve stem 120 and engage second surface 24 of retainer 20, which creates constant pressure between annular ledge 60 of retainer 20 and second surface 114 of flexible valve head 110, creating a seal.

FIG. 6 shows valve assembly 10 in the closed position. In this position, second surface 114 of flexible valve head 110 engages annular ledge 60 to form a seal so that a significant amount of fluid cannot escape through aperture 50. Second surface 114 and annular ledge 60 are held in contact by legs 130, 140 pressing against second surface 24 of retainer 20, creating constant pressure between flexible valve head 110, retainer 20, and legs 130, 140. The valve assembly exists in the closed position when fluid pressure against second surface 114 of flexible valve head 110 is below a predetermined set point.

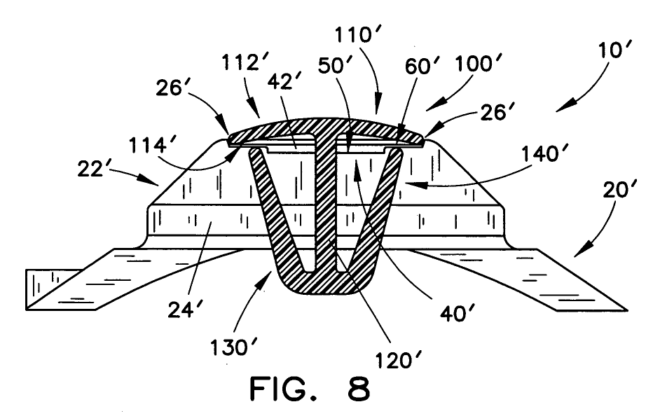

FIG. 7 shows valve assembly 10 in an open position. In this position, second surface 114 of flexible valve head 110 and annular ledge 60 are spaced apart such that fluid can flow through aperture 50. Valve assembly 10 opens when fluid pressure against second surface 114 of flexible valve head 110 reaches a predetermined set point. At that point, the fluid presses against second surface 114 with sufficient force to raise flexible valve head 110 and cause legs 130, 140 to flex outwardly from valve stem 120. This disengages second surface 114 of flexible valve head 110 from annular ledge 60 of retainer 20, opening aperture 50. Fluid then flows through aperture 50. When the fluid pressure against second surface 114 of flexible valve head 110 drops below the predetermined set point, legs 130, 140 return to their original position, thereby returning valve assembly 10 to the closed position.

Those of skill in the art will understand that valve 100 can be made of plastic using several known techniques, including injection molding. Because injection molding is typically a repeatable process, valve 100 can be made so that legs 130, 140, as well as the connections between legs 130, 140 and valve stem 120, will flex to allow the seal between flexible valve head 110 and annular ledge 60 to release when the fluid pressure reaches a predetermined set point. Methods of creating the injection-molded pieces are well known to those of skill in the art.

The fluid pressure required to disengage valve 100 from retainer 20, i.e., the predetermined set point, will vary depending on the circumstances. The specific application in which valve 100 is used will dictate the predetermined set point. Those of ordinary skill in the art will readily understand that the predetermined set point is calibrated for each valve embodiment by changing one or more of at least three primary factors: (1) the size of aperture 50 of retainer 20; (2) the geometry of legs 130, 140, valve stem 120, and flexible valve head 110; and (3) the material used to make valve 100. For example, a larger aperture 50 will enable valve 100 and retainer 20 to disengage at a lower fluid pressure than when aperture 50 is smaller. Similarly, when valve 100 is made from a relatively stiffer material, the pressure at which valve 100 and retainer 20 will disengage is higher than when valve 100 is made from a more flexible material. By varying one or more of these primary factors, a person of ordinary skill in the art can develop a suitable predetermined set point for using one or more embodiments of the present invention in a variety of applications. Persons of ordinary skill in the art will recognize that such calibration may be aided by using commercially-available finite element analysis software packages.

Although it is preferable for legs 130, 140 to attach to valve stem 120 at the farthest point from flexible valve head 110, as shown in FIGS. 4 and 5, attachment may be at any point on valve stem 120 so long as legs 130, 140 are sized to exert the proper amount of constant pressure against second surface 24 of retainer 20 when valve assembly 10 is in the closed position.

FIG. 8 shows another embodiment of a fluid valve assembly of the present invention. In this embodiment, valve assembly 10′ comprises retainer 20′ and valve 100′. First surface 22′ of retainer 20′ is substantially convex and second surface 24′ of retainer 20′ is substantially concave. Retainer 20′ includes inside annular edge 40′, which defines aperture 50′. Along inside annular edge 40′ is lip 42′. Annular ledge 60′ is that portion of first surface 22′ of retainer 20′ that circumferentially surrounds inside annular edge 40′ and lip 42′. Ridge 26′ circumferentially surrounds annular ledge 60′.

Valve 100′ fits within aperture 50′ and includes flexible valve head 110′, valve stem 120′, and legs 130′, 140′. Flexible valve head 110′ has first surface 112′ and second surface 114′. In the embodiment shown in FIG. 8, flexible valve head 110′ has a circular circumferential shape and fits against the depressed portion of first surface 22′ of retainer 20′ between ridge 26′ and lip 42′. Second surface 114′ of flexible valve head 110′ engages annular ledge 60′ when valve 100′ and retainer 20′ are fully engaged. Ridge 26′ is sufficiently pronounced to serve as a guide to align flexible valve head 110′ in the proper position against annular ledge 60′ when flexible valve head 110′ is brought into contact with annular ledge 60′ during closing of valve assembly 10′. Similarly, lip 42′ is sufficiently extended to help align legs 130′, 140′ during opening and closing of valve assembly 10′.

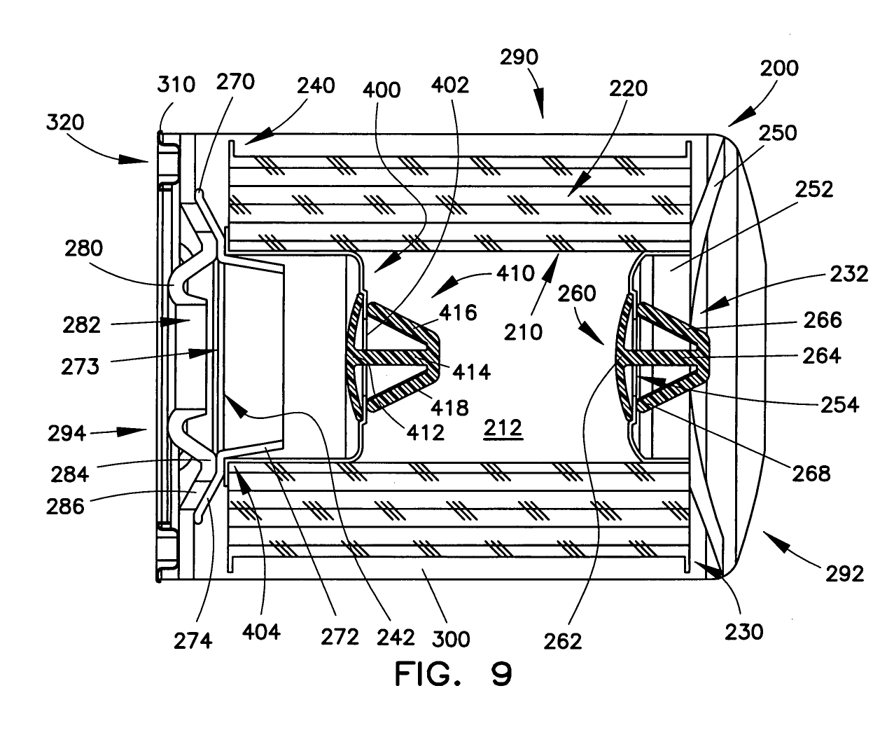

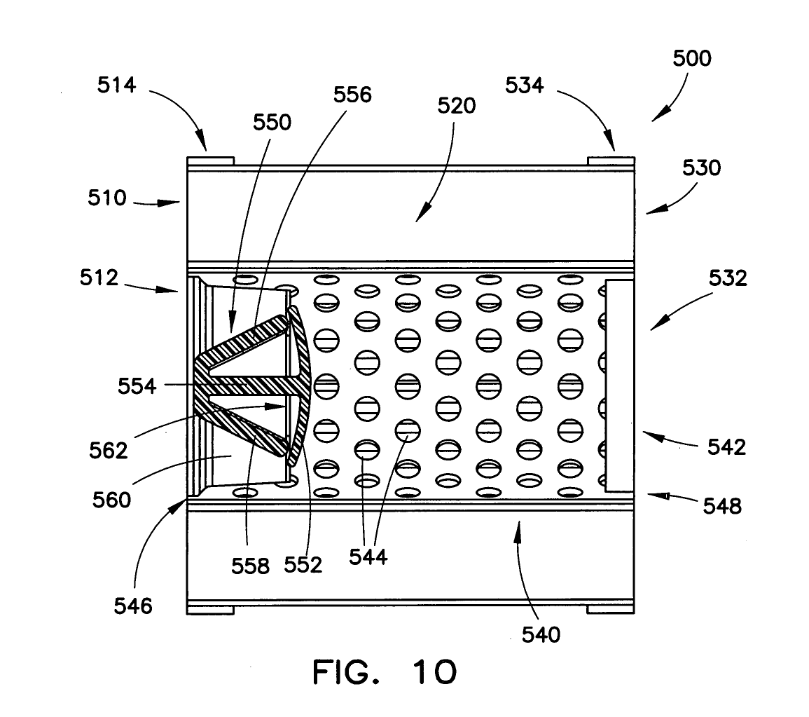

Referring now to FIG. 9, there is shown one embodiment of a fluid filter of the present invention. In this embodiment, fluid filter 200 comprises center tube 210, which is cylindrical and generally hollow, defining middle cavity 212. Center tube 210 contains multiple holes through which fluid can flow transversely into middle cavity 212, and center tube 210 is substantially open at both ends so that fluid may flow longitudinally through center tube 210. Center tube 210 may be made from any suitable material, such as steel or plastic.

Formed circumferentially around the outside of center tube 210 is filter media 220, which is cylindrically shaped and is approximately the same length as center tube 210. Filter media 220 is preferably made of pleated paper, but those of skill in the art will recognize that filter media 220 may be made of any suitable material capable of filtering fluid. Many such suitable filtering materials are well known.

Fluid filter 200 further comprises top end cap 230 and bottom end cap 240. As shown in FIG. 9, top end cap 230 is relatively thin and substantially disc-shaped. Top end cap 230 is attached to one end of center tube 210 and filter media 220. Top end cap 230 preferably has approximately the same circumference as the outside surface of filter media 220, as shown in FIG. 9, but may be larger in circumference. Formed generally in the center of top end cap 230 is top opening 232, which has approximately the same diameter as center tube 210 such that the open end of center tube 210 generally corresponds to top opening 232 of top end cap 230. Top opening 232 may be larger or smaller in diameter than the open end of center tube 210, so long as top end cap 230 does not prevent fluid access through the open end of center tube 210 to middle cavity 212. Top end cap 230 may be made from almost any material with sufficient strength, for example, steel, cardboard, or plastic.

Bottom end cap 240, which is relatively thin and substantially disc-shaped as shown in FIG. 9, is attached to the opposite end of center tube 210 and filter media 220 from the end to which top end cap 230 is attached. Bottom end cap 240 preferably has approximately the same circumference as the outside surface of filter media 220, as shown in FIG. 9, but may be larger in circumference. Formed generally in the center of bottom end cap 240 is bottom opening 242, which has approximately the same diameter as center tube 210 such that the open end of center tube 210 generally corresponds to bottom opening 242 of bottom end cap 240. Bottom opening 242 may be larger or smaller in diameter than the open end of center tube 210, so long as bottom end cap 240 does not prevent fluid access through the open end of center tube 210 to middle cavity 212.

Fluid filter 200 further comprises retainer 250 and valve 260. Retainer 250 is substantially conical and includes substantially cylindrical portion 252 that houses valve 260, as shown in FIG. 9. Valve 260 fits substantially within bypass aperture 254 formed in the apex of substantially cylindrical portion 252. Bypass aperture 254 is preferably substantially circular, but may be of any suitable shape. Valve 260 includes flexible valve head 262, valve stem 264, and legs 266, 268. Flexible valve head 262 is formed in the same general circumferential shape as bypass aperture 254 so that flexible valve head 262 can cover bypass aperture 254, as shown in FIG. 9, when valve 260 and retainer 250 are fully engaged. When valve 260 and retainer 250 are fully engaged, flexible valve head 262 and retainer 250 form a seal through which substantial fluid cannot pass, and therefore substantial fluid is prevented from flowing through bypass aperture 254. However, when valve 260 and retainer 250 are not fully engaged, substantial fluid can pass through bypass aperture 254 into middle cavity 212.

Substantially cylindrical portion 252 of retainer 250 is configured in size and shape to be inserted through top opening 232 of top end cap 230 and into the end of center tube 210, as shown in FIG. 9. Insertion of substantially cylindrical portion 252 of retainer 250 into center tube 210 closes top opening 232 of top end cap 230 so that little or no fluid can pass through top opening 232, except through bypass aperture 254 of retainer 250 when valve 260 and retainer 250 are not fully engaged.

Fluid filter 200 further comprises anti-drain back gasket 270, which includes raised lip 272 and outer flange 274. Raised lip 272 forms substantially circular opening 273 and is configured in size and shape to fit within bottom opening 242 of bottom end cap 240 and the corresponding open end of center tube 210, such that fluid in middle cavity 212 can exit middle cavity 212 through substantially circular opening 273 of anti-drain back gasket 270. Outer flange 274 extends radially from the bottom of raised lip 272 such that substantial fluid cannot escape from middle cavity 212 through bottom opening 242 of bottom end cap 240 except through substantially circular opening 273 of anti-drain back gasket 270.

Held against the underside of outer flange 274 of anti-drain back gasket 270 is tapping plate 280. Tapping plate 280 includes center opening 282, the inner wall of which is threaded to removably engage a threaded fluid receptacle (not shown), such as on an automotive engine. Tapping plate 280 further includes raised ridge 284, which is configured to surround center opening 282 and engage the underside of anti-drain back gasket 270 to form a seal through which substantial fluid cannot pass. Tapping plate 280 also includes outer openings 286 located radially from raised ridge 284.

Canister 290 is generally cylindrical with closed end 292 and open end 294 and is configured to enclose filter media 220, retainer 250, and tapping plate 280. The outside edge of retainer 250 is configured to fit within canister 290 and to hold filter media 220 stable within canister 290. Canister 290 surrounds filter media 220, but between the inside surface of canister 290 and the outside surface of filter media 220 is outer circumferential space 300.

Outer flange 274 of anti-drain back gasket 270 covers outer openings 286 and is configured so that fluid can flow through outer openings 286 and into outer circumferential space 300, but cannot flow from outer circumferential space 300 through outer openings 286. In this way, anti-drain back gasket 270 prevents fluid from draining back out of canister 290, except through substantially circular opening 273 of anti-drain back gasket 270. Anti-drain back gasket 270 may be made of rubber or any suitable material with sufficient flexibility to permit proper fluid flow through outer openings 286.

Bottom plate 310 is configured to attach to open end 294 of canister 290 so that a significant amount of fluid cannot leak through the connection. Bottom plate 310 includes a center opening through which substantial fluid can flow and, on its outer surface, a circumferential groove that holds o-ring 320 or any other structure suitable for sealing (e.g., a gasket). O-ring 320 is configured to form a fluid-tight seal between fluid filter 200 and its fluid source (not shown) when filter 200 is attached to the fluid source.

Bottom plate 310 and canister 290 may be made of steel, plastic, or any other suitable material. O-ring 320 is preferably made of rubber or any material suitable for creating a seal.

As assembled, fluid filter 200 accepts a flow of fluid, filters the fluid through filter media 220, and then returns the fluid in a substantially filtered state. When fluid filter 200 is operating in a normal state, fluid enters fluid filter 200 through the opening in bottom plate 310, then flows through outer openings 286 in tapping plate 280, into outer circumferential space 300 between canister 290 and filter media 220, and transversely through filter media 220 and center tube 210 to middle cavity 212. Then, the fluid returns to its source in a substantially filtered state by exiting middle cavity 212 through opening 273 in anti-drain back gasket 270 and center opening 282 of tapping plate 280.

However, fluid filter 200 permits the continuous flow of fluid to its destination even when filter media 220 is clogged. When fluid cannot pass through filter media 220 because of a clog, fluid pressure builds in outer circumferential space 300 and in the space between retainer 250 and canister 290. When the fluid pressure rises to a predetermined bypass set point, valve 260 is pushed away from retainer 250, disengaging flexible valve head 262 from retainer 250 so that fluid flows through bypass aperture 254 and therefore enters middle cavity 212. The unfiltered fluid exits middle cavity 212 to its source in the same way that the filtered fluid exits, through opening 273 in anti-drain back gasket 270 and center opening 282 of tapping plate 280. When the filter is in a bypass situation, the fluid returns to its source without filtering, but this is more desirable than allowing the fluid flow to stop because the filter media is clogged.

Referring again to FIG. 9, there is shown an optional means to prevent fluid backflow into fluid filter 200, namely anti-siphon housing 400 and anti-siphon valve 410. Anti-siphon housing 400 includes orifice 402 and circumferential flange 404. Anti-siphon housing 410 is substantially located within middle cavity 212 of center tube 210 and encloses opening 273 of anti-drain back gasket 270 such that substantial fluid cannot flow through opening 273 of anti-drain back gasket 270 into middle cavity 212 unless it flows through orifice 402 of anti-siphon housing 400. Circumferential flange 404 of anti-siphon housing 400 fits between bottom end cap 240 and anti-drain back gasket 270.

Anti-siphon valve 410, which consists of anti-siphon flexible valve head 412, anti-siphon valve stem 414, and anti-siphon valve legs 416, 418, fits substantially within orifice 402 of anti-siphon housing 400. Anti-siphon flexible valve head 412 is configured to substantially close orifice 402 to fluid flow when anti-siphon valve 410 and anti-siphon housing 400 are fully engaged.

Like valve 260, anti-siphon valve 410 operates according to fluid pressure. Anti-siphon valve 410 is open to permit substantial fluid flow through orifice 402 when fluid pressure within middle cavity 212 is above a predetermined set point. However, when the fluid pressure in middle cavity 212 drops below the predetermined set point, anti-siphon flexible valve head 412 engages anti-siphon housing 400 to close orifice 402 so that a substantial amount of fluid cannot flow through orifice 402. This prevents fluid from the fluid source (not shown) from flowing backwards through center opening 282 of tapping plate 480 and into middle cavity 212 of fluid filter 200.

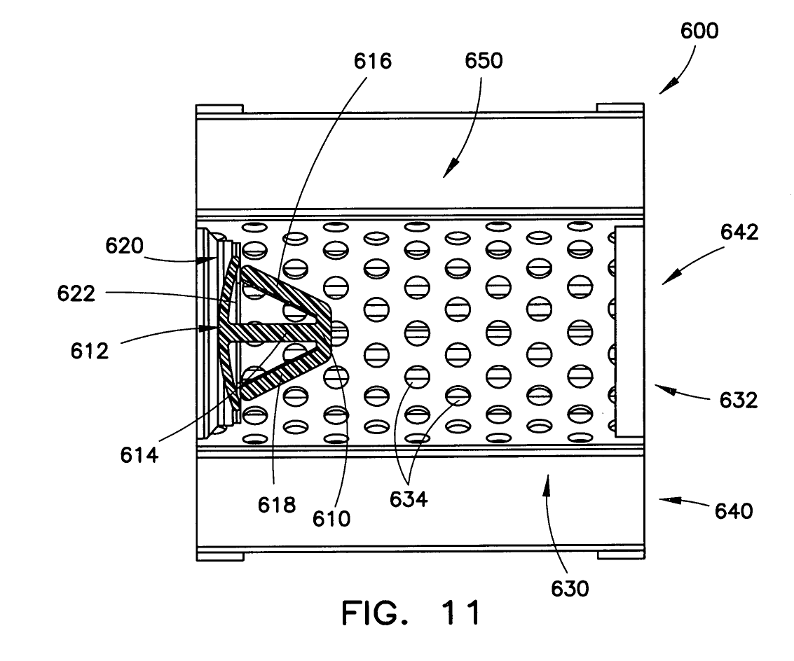

Referring now to FIG. 10, there is shown one embodiment of a cartridge fluid filter of the present invention. In this embodiment, cartridge fluid filter 500 comprises top end cap 510, filter media 520, bottom end cap 530, center tube 540, relief valve 550, and retainer 560. Center tube 540 is cylindrical, is generally hollow, and defines middle cavity 542. Center tube 540 contains multiple holes 544 through which fluid can flow into middle cavity 542. In addition, center tube 540 has first end 546 and second end 548 and is substantially open at both ends 546, 548 so that fluid may flow longitudinally through center tube 540. Center tube 540 may be made of any suitable material, such as steel or plastic.

Formed circumferentially around the outside of center tube 540 is filter media 520, which is cylindrically shaped.

Top end cap 510 may be substantially disc-shaped and defines top opening 512. Top end cap 510 may have approximately the same circumference as the outside surface of filter media 520, but may be larger in circumference than the outside surface of filter media 520. Circumferentially disposed around the outside of top end cap 510 is top lip 514, which extends axially toward bottom end cap 530 and attaches to filter media 520, as shown in FIG. 10. Top opening 512 is generally no larger in diameter than center tube 540. Top opening 512 may have a smaller diameter than that of center tube 540, so long as it is large enough to accommodate relief valve 550 and retainer 560.

Bottom end cap 530 may be substantially disc-shaped and defines bottom opening 532. Bottom end cap 530 may have approximately the same circumference as the outside surface of filter media 520, but may be larger in circumference than the outside surface of filter media 520. Circumferentially disposed around the outside of bottom end cap 530 is bottom lip 534, which extends axially toward top end cap 510 and attaches to filter media 520, as shown in FIG. 10. Bottom opening 532 is generally no larger in diameter than center tube 540. Bottom opening 532 may have a smaller diameter than that of center tube 540, so long as substantial fluid may pass through bottom opening 532.

Retainer 560 of cartridge fluid filter 500 fits within top opening 512 of top end cap 510 and first end 546 of center tube 540, as shown in FIG. 10. Retainer 560 comprises bypass aperture 562 and is configured to close first end 546 of center tube 540 so that substantial fluid cannot flow through first end 546 of center tube 540 unless it flows through bypass aperture 562 of retainer 560. Bypass aperture 562 is preferably substantially circular, but may be of any shape.

In some embodiments of a cartridge fluid filter made according to various aspects of the present invention, retainer 560 is integral with top end cap 510.

Relief valve 550 of cartridge fluid filter 500 includes flexible valve head 552, valve stem 554, and legs 556, 558. In the embodiment shown in FIG. 10, relief valve 550 fits substantially within bypass aperture 562 of retainer 560. Flexible valve head 552 is formed in the same general circumferential shape as bypass aperture 562, so that flexible valve head 552 can cover bypass aperture 562, as shown in FIG. 10, when relief valve 550 and retainer 560 are fully engaged. When relief valve 550 and retainer 560 are fully engaged, flexible valve head 552 engages the inner surface of retainer 560 to form a seal through which substantial fluid cannot pass, and substantial fluid is prevented from flowing through bypass aperture 562 and therefore top opening 512. However, when relief valve 550 and retainer 560 are not fully engaged, flexible valve head 552 and retainer 560 do not form a seal, and substantial fluid can pass through bypass aperture 562 and top opening 512.

Referring again to FIG. 10, cartridge fluid filter 500 is configured for standard fluid flow inside a fluid filter assembly (not shown) such that fluid flows laterally from outside cartridge 500 through filter media 520, through multiple holes 544 of center tube 540 and out bottom opening 532 of bottom end cap 530. During normal operation of cartridge 500, relief valve 550 and retainer 560 are fully engaged so that substantial fluid is prevented from passing through bypass aperture 562 and top opening 512. However, when filter media 520 becomes sufficiently clogged that fluid cannot pass into cartridge fluid filter 500, fluid pressure in the filter assembly (not shown) and around cartridge fluid filter 500 rises. When the fluid pressure reaches a predetermined bypass set point, relief valve 550 disengages from retainer 560, permitting substantial fluid flow through bypass aperture 562 into middle cavity 542 and out bottom opening 532 of bottom end cap 530. In this way, cartridge fluid filter 500 prevents substantial loss of fluid flow when filter media 520 becomes clogged, thereby preventing damage.

The embodiment of a fluid filter cartridge of the present invention shown in FIG. 11 is similar to cartridge fluid filter 500 shown in FIG. 10, except that cartridge fluid filter 600 of FIG. 11 is configured for reverse fluid flow. In cartridge fluid filter 600, relief valve 610 is configured such that flexible valve head 612 engages retainer 620 and thereby closes bypass aperture 622. As such, valve stem 614 and legs 616, 618 extend into middle cavity 632 of center tube 630.

When cartridge fluid filter 600 is operating normally in a fluid filter assembly (not shown), fluid enters bottom opening 642 of bottom end cap 640 into middle cavity 632. The fluid then flows through multiple holes 634 of center tube 630 into and through filter media 650, exiting cartridge fluid filter 600 to the fluid filter assembly (not shown) so that the filtered fluid can continue to its destination. However, when filter media 650 is clogged such that fluid does not pass through filter media 650 and out of cartridge fluid filter 600, fluid pressure builds in middle cavity 632 of center tube 630. When the pressure in middle cavity 632 reaches a predetermined bypass set point, flexible valve head 612 disengages from retainer 620 so that fluid escapes through bypass aperture 622, thereby exiting cartridge fluid filter 600 and continuing to its destination in an unfiltered state.

As will be understood by those of skill in the art, fluid valve assemblies and fluid filters made according to various aspects of the present invention have fewer parts, are easier to manufacture, and are less expensive to produce than many other valves and filters, particularly those traditional valves and filters having a steel retainer, plastic valve, and steel spring. In addition, the parts used to make valves and filters of various embodiments of the present invention cost less to handle and store than parts for more complex valves and filters.

The present invention can be further modified within the scope and spirit of this disclosure. It will be understood by those of skill in the art that the preferred embodiments disclosed herein describe the present invention in detail, but do not limit or restrict the scope of the invention. The disclosure is intended to cover any variations, uses, or adaptations of the invention using its general principles. Further, this disclosure is intended to cover such departures from the disclosed embodiments as come within known or customary practice in the art to which this invention pertains and which fall within the limits of the appended claims.

I claim:

1. An integrated valve assembly, comprising:
a retainer having a first surface and an opposing second surface, said retainer having an inside annular edge formed around an aperture in said retainer, wherein disposed circumferentially adjacent to said inside annular edge on said first surface is an annular ledge; and
an integrated valve disposed through said aperture, said integrated valve comprising (i) a flexible valve head having a first surface and an opposing second surface that is generally concave, said second surface of said flexible valve head for removably engaging said annular ledge such that said aperture is reversibly sealed to prevent substantial fluid flow through said aperture, (ii) a valve stem attached to said second surface of said flexible valve head and extending through said aperture, and (iii) at least one leg attached to said valve stem, wherein said at least one leg exerts pressure on said retainer to cause said flexible valve head to reversibly seal said aperture and to allow said flexible valve head to disengage from said annular ledge to open said aperture according to fluid pressure.

2. The integrated valve assembly of claim 1, wherein:
said first surface of said flexible valve head is substantially convex.

3. The integrated valve assembly of claim 2, wherein:
said inside annular edge is substantially circular such that said aperture is substantially circular.

4. The integrated valve assembly of claim 3, wherein:
said valve stem extends substantially axially from said valve head.

5. The integrated valve assembly of claim 4, wherein:
said at least one leg comprises two legs.

6. The integrated valve assembly of claim 5, wherein:
said valve stem attaches to the center of said second surface of said flexible valve head.

7. The integrated valve assembly of claim 6, wherein:
said first surface of said retainer is substantially convex and said second surface of said retainer is substantially concave.

8. The integrated valve assembly of claim 7, wherein:
said retainer further includes a substantially cylindrical portion.

9. The integrated valve assembly of claim 8, wherein:
said retainer is made of metal.

10. The integrated valve assembly of claim 9, wherein:
said valve is made of plastic.

11. A fluid filter with relief valve assembly, comprising:
a canister having a substantially open end and a closed end;
a bottom plate attached to said open end of said canister and having an outer surface and an inner surface, said bottom plate defining a hole for fluid communication into and out of said canister;
a center tube within said canister, said center tube defining a middle cavity;
a filter media circumferentially surrounding said center tube within said canister, said filter media having a first end and a second end and defining a circumferential space for fluid flow between said canister and said filter media;
a top end cap defining a top opening, said top end cap being attached to said first end of said filter media;
a bottom end cap defining a bottom opening, said bottom end cap being attached to said second end of said filter media;
a retainer disposed between said closed end of said canister and said top end cap and extending partially through said top opening of said top end cap, said retainer having a first surface and an opposing second surface and defining a bypass aperture in said retainer;
a valve disposed through said bypass aperture, said valve comprising (i) a flexible valve head having a first surface and an opposing second surface that is generally concave, said second surface of said valve head for removably engaging said first surface of said retainer such that said bypass aperture is reversibly sealed to prevent substantial fluid flow through said bypass aperture, (ii) a valve stem attached to said second surface of said valve head and extending through said bypass aperture, and (iii) at least one leg attached to said valve stem, wherein said at least one leg exerts pressure on said retainer to cause said flexible valve head to reversibly seal said bypass aperture and to allow said flexible valve head to disengage from said annular ledge to open said bypass aperture when the fluid pressure in said circumferential space raises to a predetermined set point;
a tapping plate defining a center opening for fluid communication out of said middle cavity and defining an outer opening for fluid communication into said circumferential space between said canister and said filter media; and
an anti-drain back gasket defining a conduit for fluid communication between said middle cavity and said center opening of said tapping plate.

12. The fluid filter with relief valve assembly of claim 11, further comprising:
an o-ring attached to said outer surface of said bottom plate, wherein said o-ring is disposed within a groove in said bottom plate.

13. The fluid filter with relief valve assembly of claim 12, wherein:
said valve stem extends substantially axially from said flexible valve head.

14. The fluid filter with relief valve assembly of claim 13, wherein:
said at least one leg comprises two legs.

15. The fluid filter with relief valve assembly of claim 14, wherein:
said valve is made of plastic.

16. The fluid filter with relief valve assembly of claim 15, wherein:
said flexible valve head is substantially circular in shape.

17. The fluid filter with relief valve assembly of claim 16, wherein:
said retainer is made of metal.

18. The fluid filter with relief valve assembly of claim 17, wherein:
said center tube includes at least two perforations for fluid communication between said filter media and said middle cavity.

19. The fluid filter with relief valve assembly of claim 18, further comprising:
an anti-siphon housing disposed within said middle cavity and surrounding said conduit of said anti-drain back gasket, said anti-siphon housing defining an orifice for fluid communication between said middle cavity and said conduit of said anti-drain back gasket; and
an anti-siphon valve disposed through said orifice.

20. The fluid filter with relief valve assembly of claim 19, wherein:
said anti-siphon valve comprises (i) an anti-siphon flexible valve head having a first surface and an opposing second surface, said second surface of said anti-siphon valve head for removably engaging said anti-siphon housing such that said orifice is reversibly sealed to prevent substantial fluid flow through said orifice, (ii) an anti-siphon valve stem attached to said second surface of said flexible anti-siphon valve head and extending through said orifice, and (iii) at least one anti-siphon valve leg attached to said anti-siphon valve stem.

21. The fluid filter with relief valve assembly of claim 20, wherein:
said anti-siphon valve stem extends substantially axially from said anti-siphon valve head.

22. The fluid filter with relief valve assembly of claim 21, wherein:
said anti-siphon valve is made of plastic.

23. A cartridge fluid filter with relief valve assembly, comprising:
a center tube defining a middle cavity, said center tube having a first end defining a first fluid passage and a second end defining a second fluid passage;
a filter media circumferentially surrounding said center tube, said filter media having a first end adjacent to said first end of said center tube and a second end adjacent to said second end of said center tube;
a top end cap defining a top opening in fluid communication with said first fluid passage, said top end cap attached to said first end of said filter media;
a bottom end cap defining a bottom opening in fluid communication with said second fluid passage, said bottom end cap attached to said second end of said filter media;
a retainer disposed within said top opening of said top end cap, said retainer having an inner surface and an opposing outer surface and defining a bypass aperture in said retainer;
a relief valve disposed through said bypass aperture of said retainer, said relief valve comprising (i) a flexible valve head having a first surface and an opposing second surface that is generally concave, said second surface of said flexible valve head for removably engaging said retainer such that said bypass aperture is reversibly sealed to prevent substantial fluid flow through said bypass aperture, (ii) a valve stem attached to said second surface of said flexible valve head and extending through said bypass aperture, and (iii) at least one leg attached to said valve stem, wherein said at least one leg exerts pressure on said retainer to cause said flexible valve head to reversibly seal said bypass aperture and to allow said flexible valve head to disengage from said retainer to open said bypass aperture according to fluid pressure.

24. The cartridge fluid filter with relief valve assembly of claim 23, wherein:
said flexible valve head removably engages said inner surface of said retainer such that said bypass aperture is reversibly sealed to prevent substantial fluid flow through said bypass aperture.

25. The cartridge fluid filter with relief valve assembly of claim 23, wherein:
said flexible valve head removably engages said outer surface of said retainer such that said bypass aperture is reversibly sealed to prevent substantial fluid flow through said bypass aperture.

26. The cartridge fluid filter with relief valve assembly of claim 24, wherein:
said relief valve is made of plastic.

27. The cartridge fluid filter with relief valve assembly of claim 26, wherein:
said center tube is substantially cylindrical in shape; and
said bypass aperture is substantially circular in shape.

28. The cartridge fluid filter with relief valve assembly of claim 27, wherein:
said top end cap is substantially circular in shape; and
said bottom end cap is substantially circular in shape.

29. The cartridge fluid filter with relief valve assembly of claim 28, wherein:
said at least one leg comprises two legs.

30. An integrated fluid valve assembly, comprising:
a retainer having a first surface and an opposing second surface, said retainer having an inside annular edge formed around a substantially circular aperture in said retainer, wherein disposed circumferentially adjacent to said inside annular edge on said first surface is an annular ledge; and
an integrated valve disposed through said aperture, said integrated valve comprising (i) a flexible valve head having a first surface that is generally convex and an opposing second surface that is generally concave, said second surface of said flexible valve head for removably engaging said annular ledge such that said aperture is reversibly sealed to prevent substantial fluid flow through said aperture, (ii) a valve stem attached to the approximate center of said second surface of said flexible valve head, said valve stem extending axially through said aperture, and (iii) two or more legs attached to said valve stem, wherein said two or more legs exert pressure on said second surface of said retainer to cause said flexible valve head to reversibly seal said aperture and to allow said flexible valve head to disengage from said annular ledge to open said aperture according to fluid pressure.
